(19) United States
(12) Patent Application Publication
(10) Pub. No.: US 2018/0276904 A1
(43) Pub. Date: Sep. 27, 2018

(54) IoT Service Meter Unit Transmitter

(71) Applicant: Caterpillar Inc., Peoria, IL (US)

(72) Inventors: Kristopher Eric Shaffer, Dunlap, IL (US); Philip Carl Spengler, Washington, IL (US)

(73) Assignee: Caterpillar Inc., Peoria, IL (US)

(21) Appl. No.: 15/467,156

(22) Filed: Mar. 23, 2017

(51) Int. Cl. G07C 5/00; H04L 12/40; G07C 5/08

(52) U.S. Cl. CPC G07C 5/008; H04L 12/40013; H04L 2012/40215; G07C 5/0808; H04L 12/40045

(57) ABSTRACT

A method for servicing an apparatus based on the time of operation of the apparatus, wherein the apparatus includes a controller BUS and a diagnostic port in communication with the BUS, comprises plugging a service meter unit into the diagnostic port and sending a signal related to the time of operation of the apparatus or other service meter unit to a location remote from the apparatus.

### TECHNICAL FIELD

The present disclosure relates to methods and devices to smart enable or connectedly equip machines such as highway trucks, cars, earth moving, construction and mining equipment and the like having a diagnostic BUS or service meter as originally sold or in the aftermarket. Specifically, the present disclosure relates to a dongle that can smart enable or connectedly equip such machines as originally sold or in an aftermarket context.

### BACKGROUND

Earth moving, construction and mining equipment and the like work in harsh environments and require periodic maintenance. It is often helpful to perform such maintenance before certain problems occur in the field, which can lead to down time, and inconvenience sometimes in transporting the down equipment to a service center or the like. For example, data may be available that suggests when certain machines should be brought in for maintenance before certain problems occur. However, in order to take advantage of such data, it is necessary to know how many hours of operation a particular machine has had from first being sold or from the last maintenance interval, etc. Of course, similar problems exist for equipment of all types including commercial mowers, etc.

Currently, there is no easy way to track such data for a particular machine. In some cases, this functionality may be provided with a machine when new but this does not solve the problem for equipment that is already in the field.

Accordingly, a need exists for a method and apparatus that may be used to track the hours of operation or other service meter units of a machine and convey that information back to a fleet service center or the like so that a machine may be brought in for maintenance at the proper time. It would be particularly useful if such a method or device could be used with existing equipment already in the field in an easy and inexpensive manner.

### SUMMARY

A device for tracking or relaying a service meter unit of an apparatus that includes a diagnostic port is provided. The device comprises a plug interface including at least one voltage receiving member and a transmitter that is configured to send a signal to a location remote from the device when the device receives voltage from the plug interface.

An apparatus is provided comprising a controller including a controller BUS, a BUS diagnostic port including a connector in communication with the BUS, and a service meter unit connected to the diagnostic port, the service meter unit including a transmitter configured to send a signal to a location remote from the apparatus when the service meter unit receives voltage from the apparatus.

A method for servicing an apparatus based on the time of operation of the apparatus, wherein the apparatus includes a controller BUS and a diagnostic port in communication with the BUS, is provided. The method comprises plugging a service meter unit into the diagnostic port and sending a signal conveying service meter units of the apparatus to a location remote from the apparatus.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 illustrates various forms of equipment that may use a device or method according to various embodiments of the present disclosure for tracking and sending data concerning the tracked hours of operation of the equipment or other type of service meter units.

FIG. 2 is an enlarged front view depicting the pins of a connector that can interface in a complimentary manner with a device according to an embodiment of the present disclosure that can track and report the hours of operation or other types of service meter units of the engine or another apparatus.

FIG. 3 contains a schematic showing various embodiments of a device and a method for tracking the service meter units such as the hours of operation of a piece of equipment and reporting these hours or other service meter units to a fleet service center or the like as desired or needed.

FIG. 4 is a flowchart showing a method of servicing equipment based on the time of operation or other service meter units of the equipment.

FIG. 5 is an alternate schematic showing various embodiments of a device for tracking service meter units that does not need to interface with a BUS.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of devices that may be used with an apparatus for monitoring and reporting the time of operation for an apparatus or other types of service meter units will be described herein. Among these embodiments, a service meter unit that is simply and inexpensively constructed may be plugged into a diagnostic port of an apparatus such as construction, earth moving and mining equipment, on highway trucks, passenger vehicles, or engines associated therewith, etc. Any of this equipment may use various industry standard data protocols such as J1850, J1939, J1708, etc.

Once plugged in, the service meter unit or other similar device may send a signal relaying data concerning the service meter units such as the time of operation of the apparatus to a remote location such as a fleet service center. Once enough time has passed or other type of service meter unit has reached a threshold, the apparatus may be brought in and serviced, helping to prevent the failure of equipment in the field that can be more costly and time consuming than routine maintenance.

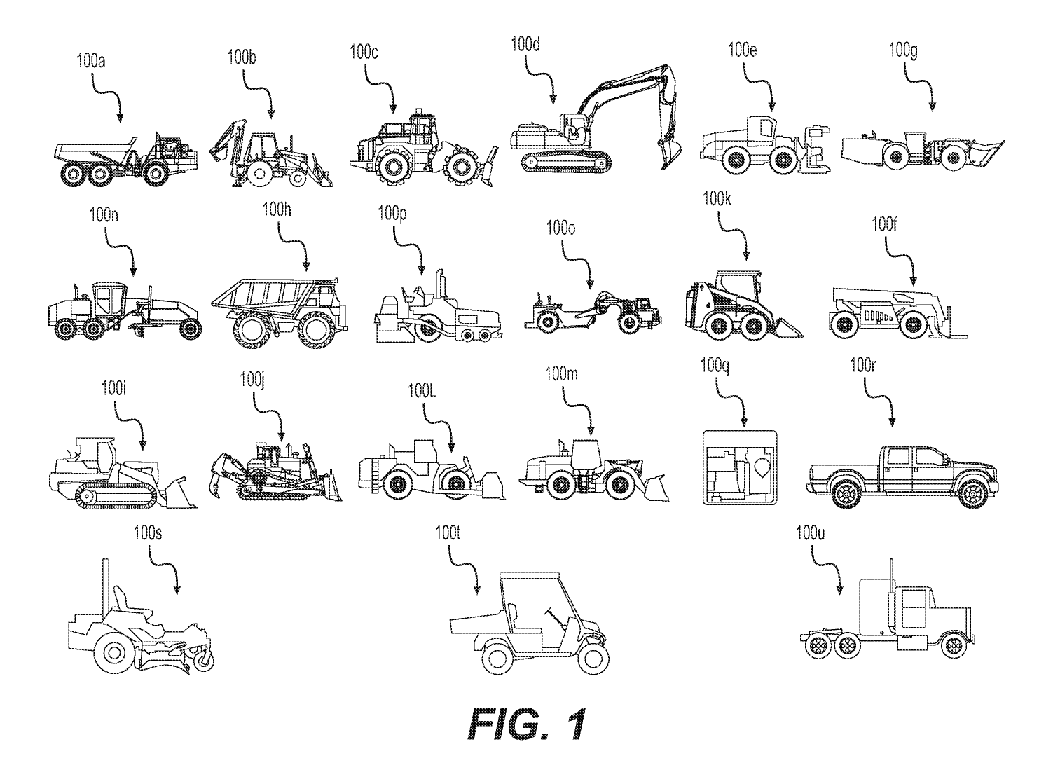

FIG. 1 depicts various embodiments of an apparatus 100 that may benefit from using a service meter unit or other similar device to track the service meter units such as the time of operation for that particular apparatus. It can be appreciated that these types of apparatus are provided by way of example only and not in any limiting sense.

Looking at FIG. 1, starting from the upper left of the top row and proceeding to the right, various types of earth moving equipment are show. The equipment includes articulated trucks 100a, backhoe loaders 100b, compactors 100c, and excavators 100d used to move soil and other materials or used to otherwise manipulate the grade or compaction of various materials including soil and the like.

Next to the earth moving equipment, an example of a foresting machine 100e, known to be useful or extracting trees, removing limbs from the trees and transporting trees, etc. is illustrated. A similar machine, a telehandler 100f, is shown in the second row at the extreme right, used to install or remove telephone poles and the like.

At the very right of the top row, a picture of mining equipment 100g is shown that has a low profile, allowing the mining equipment to transport minerals out of a mine while successfully passing through mine tunnels with a low overhead clearance.

The second and third rows also show various off-highway vehicles that may be used to move material and that are often associated with different construction projects. Specifically, trucks 100h haul material, track loaders 100i and track type tractors 100j move the material and may be able to load the truck.

Wheeled machines such as skid steer loaders 100k, wheeled dozers 100f, and wheeled loaders 100m are provided to work in areas where more stable terrain is located in the vicinity. Thus, track drives are not necessary.

Motor graders 100n, scrapers 100o and paving machines 100p may be used to create roads, parking lots, or other areas having a hard surface such as concrete or asphalt, etc.

Finally, engine or power systems 100q associated with any of these machines or that stand alone such as in a power generation context is shown at the right portion of the next to bottom row. In some cases, the engine may be used to power a boat or other off-shore/marine application.

Other similar applications that may use a device or method as described herein include locomotives, etc. For example, on road vehicles such as cars or light trucks 100r, commercial mowers 100s, site vehicles 100t such as golf carts and the like, and heavy trucks 100u, etc. may also use and be part of various embodiments of the present disclosure.

Most engines and controller BUS's used in the earth moving, mining and construction industries, etc. transmit or store data using an industry standard data protocol known as J1939. The J1939 protocol is an industrial protocol that was originally developed by various engine and automotive manufacturers but has now been adopted by the earth moving, mining, construction industries, etc. It is to be understood that various embodiments of an apparatus or device used therewith may use other protocols such as J1850, J1708, other protocols that satisfy CANBUS, etc.

In fact, J1939 may transmit its data onto a two-wire circuit known as a CAN bus (Controlled Area Network). CAN buses are used in almost all industries known today. The two wires in the circuit are designated as Can-high or Can-H and Can-Low or Can-L. CAN-H & CAN-L are not to be interpreted as data and ground. Instead, these wires provide what is known as a differential signal. The wire color designation is often yellow for CAN-H and green for CAN-L, as most manufactures follow this rule. In many applications, embedded in the J1939 data string is all the relative engine parameters including oil pressure, oil temp, coolant temp, etc. In some cases, the time of operation of the equipment is also tracked.

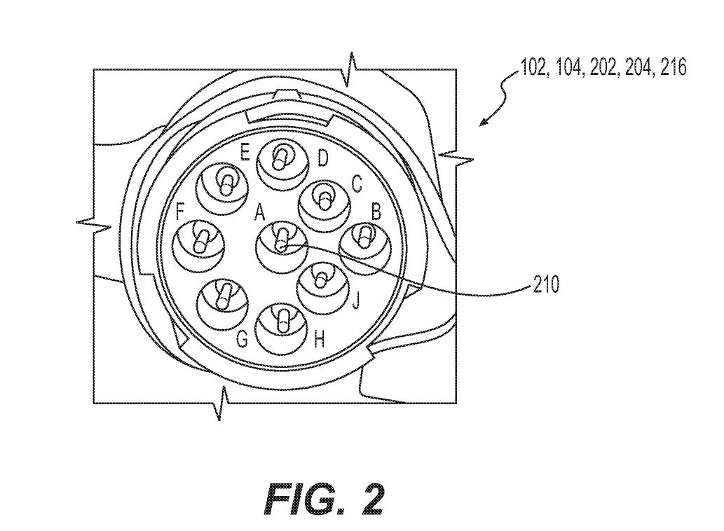

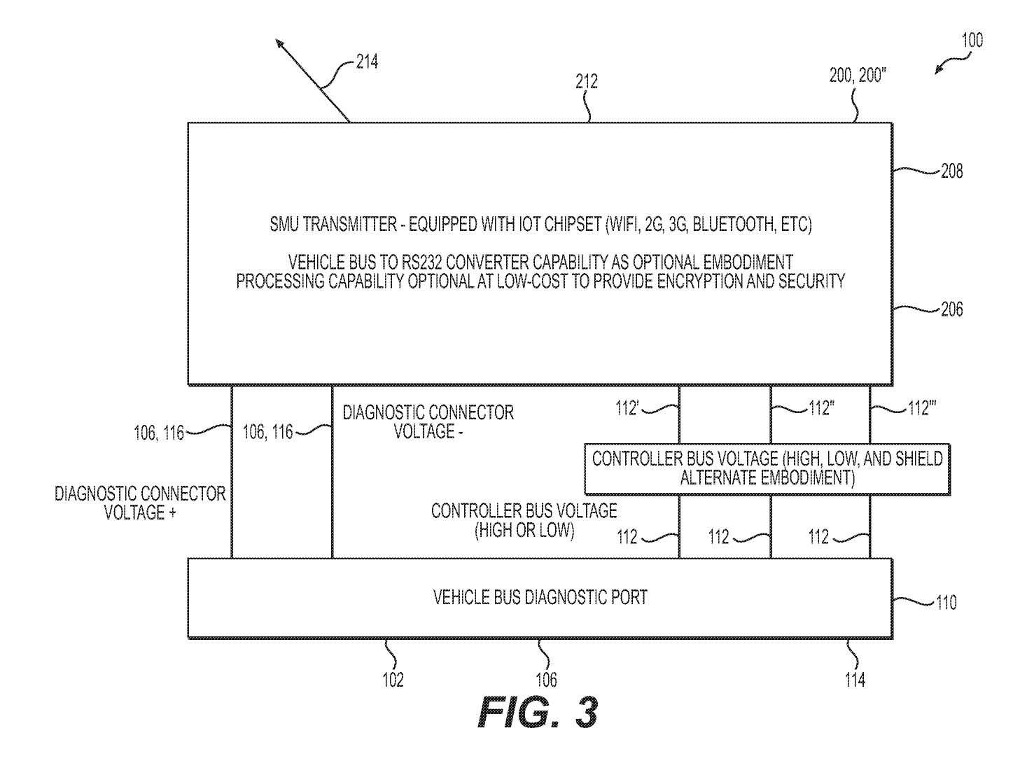

As can be understood by looking at FIGS. 2 and 3, the diagnostic connector or plug interface 202 of the device 200 or the receptacle of the apparatus 100 may include pins A-H, and J. Pin A may provide a 24 voltage signal. B may be a ground. Pin F may provide CAN-L while pin G may provide CAN-H. The plug interface 202 as shown in FIG. 2 may be the configuration used by the diagnostic port 102 or the connector portion 204 of the device 200 that is connected to the port 102. Either way, the other of the diagnostic port or device would include a plug interface that is complimentarily configured to mate with the configuration shown in FIG. 2. Other designs and location of the port may be provided depending on various parameters such as the manufacturer or the application itself, etc.

If it is desirable to actually read the J1939 data or other type of BUS, it is necessary to have a CAN (or other type of BUS/OBD standard) to Serial converter (shown schematically in FIG. 3 as 208) that is part of the device 200. More specifically, a processor 206 may be housed in the device 200 and may include a CAN (or other type of BUS/OBD standard) to Serial Converter 208 (see both FIGS. 2 and 3). The CAN (or other type of BUS/OBD standard) to Serial converter may not be necessary in other embodiments as will be described herein shortly. In such an application, the device may read the service meter unit such as mileage by readying the mileage directly off the BUS with an on-board chipset. In such a case, if it is desired not to use encryption for preventing hacking of the BUS, the mileage could be estimated using a SOC (system on a chip) that incorporates GPS logging.

Referring now to FIGS. 2 and 3, a more detailed description of a device 200 suitable for tracking the time of operation or other service meter unit of an apparatus 100, which includes a diagnostic port 102, will now be given. The device 200 may comprise a plug interface 202 including voltage receiving members 210 (see FIG. 2) such as pins or female shaped contacts that are configured to engage pins, and a transmitter 212 (see FIGS. 2 and 3) that is configured to send a signal 214 to a location remote from the device 200 when the device 200 receives voltage from the plug interface 202.

In some embodiments, as best seen in FIG. 3, the signal 214 is configured to convey the time of operation of the apparatus 100. For example, the data may be tracked by the controller BUS 110 of the apparatus. Once, the device 200 is plugged into the diagnostic port, the data concerning the amount of operation time of the apparatus 100 may be converted using a CAN (or other type of BUS/OBD standard) to serial converter 208 such as a RS232 or similar device. Then, the transmitter 212 may send the data via FSK (frequency shift keying), amplitude modulation, etc. to a remote location such as a fleet service center, dealership, manufacturer, smart phone, on board display, cloud based monitoring system etc., where the time of operation or other service meter unit may be compared to a predetermined threshold value of time, indicating that the apparatus is due for maintenance. To that end, a low end (cost) processor 206 may be provided, typically housed in the device 200 (see FIG. 3), to enable the decoding and transmission of the data such as binary or ASCII data using various devices such as an OBD reader, fleet reader, and cloud server. In these type of embodiments, the power may be received from the controller bus voltage 112 (see FIG. 3). The processor may include or connect to a back-end Web Server that may be preprogrammed within the device with customer inputs, etc.

In some embodiments, the signal 214 may also be configured to convey the identity of the apparatus 100, the identity of the device 200 or both. For example, the identity of the apparatus, such as the serial number of the apparatus, may be sent using this signal so that the remote location knows when a particular vehicle needs to be called in for maintenance.

In yet other embodiments, the processor 206 is configured to track the time the device 200 receives voltage such as BUS logic voltage. In such a case, the voltage supplied by the diagnostic connector 106 may cause the processor 206 to track the time and then send the signal 214. In other cases, the processor 206 may comprise simple hard wired logic or circuitry that automatically sends the signal 214 to the remote location once the device 200 is automatically powered up by the voltage supplied by the diagnostic connector 106. This version of the device 200 may be considered an inexpensive or simple dongle. Also, by not interfacing with the BUS, there is a smaller risk that the BUS may be hacked, attacked by malware, brute force, or other IP protocol security threats. In other words, the device may transmit hour-meter data based on the powered on time. This reduces the need for high level cryptography to protect the operation of the machine, vehicle or other device. The remote location may track the time of operation of the apparatus by equating the amount of time a signal 214 is received to be the same amount as the time of operation. The amount of voltage supplied may vary depending on the architecture of the apparatus, its controller BUS, and the device but examples include 3, 6, 12 and 24 volts.

In some applications, the data regarding the identity of the device 200 or the apparatus 100 is preprogrammed into the processor 206 before the device is plugged into the apparatus 100. This may be the case when the device 200 is manufactured and sold with the apparatus 100 when new. Otherwise, this may be done by ordering the device 200 online, at a physical location such as a store, etc. and supplying the serial number of the apparatus 100 when ordering the device 200. At which time, the device may be programmed with the necessary information or a database may correlate the device tracking number with the serial number of the apparatus. Other various methods of matching a device to an apparatus may be used.

Referring again to FIGS. 2 and 3, the device 200 may further comprise a data input interface 216 and the processor 206 is programmed with data regarding the identity of the apparatus 100 through the data input interface 216. Often, as best seen in FIG. 2, the plug interface 202 includes the data input interface 216. This may not be the case in other embodiments.

Referring now to the apparatus 100 and device used together as schematically depicted in FIG. 3, the apparatus 100 may include a controller 114 including a controller BUS 110, a BUS diagnostic port 102 including a connector 106 in communication with the BUS 110, and a service meter unit 200″ connected to the diagnostic port 102, the service meter 200″ unit including a transmitter 212 configured to send a signal 214 to a location remote from the apparatus 100 when the service meter unit 200 receives voltage from the apparatus 100.

In some embodiments, the connector 106 supplies a diagnostic connector voltage 116 and the received voltage is the diagnostic connector voltage. In other embodiments, the controller BUS 110 supplies at least one of a controller BUS high voltage 112′, controller BUS low voltage 112″ and a controller BUS shield voltage 112′″ and the received voltage is at least one of the controller BUS high voltage, the controller BUS low voltage or the controller BUS shield voltage.

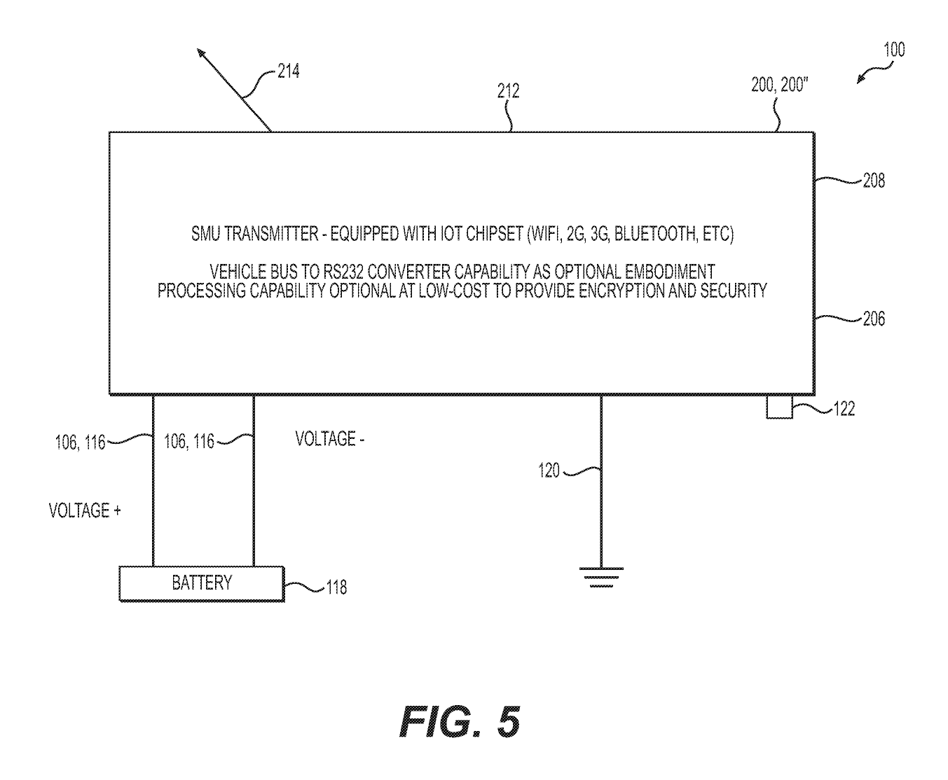

FIG. 5 is an alternate schematic showing various embodiments of a device for tracking service meter units that does not need to interface with a BUS. Instead, the voltage is supplied by a battery 118 and the device may be turned on using a power key 122 or other similar device. The device is also shown to be grounded (see reference numeral 120).

### INDUSTRIAL APPLICABILITY

In practice, an apparatus, device, service meter unit, etc. may be made, sold, used with an apparatus as original equipment or provided in the after-market context to allow the desired functionality. Any component associated with the method of use that will now be described may be sold or made separately from each other.

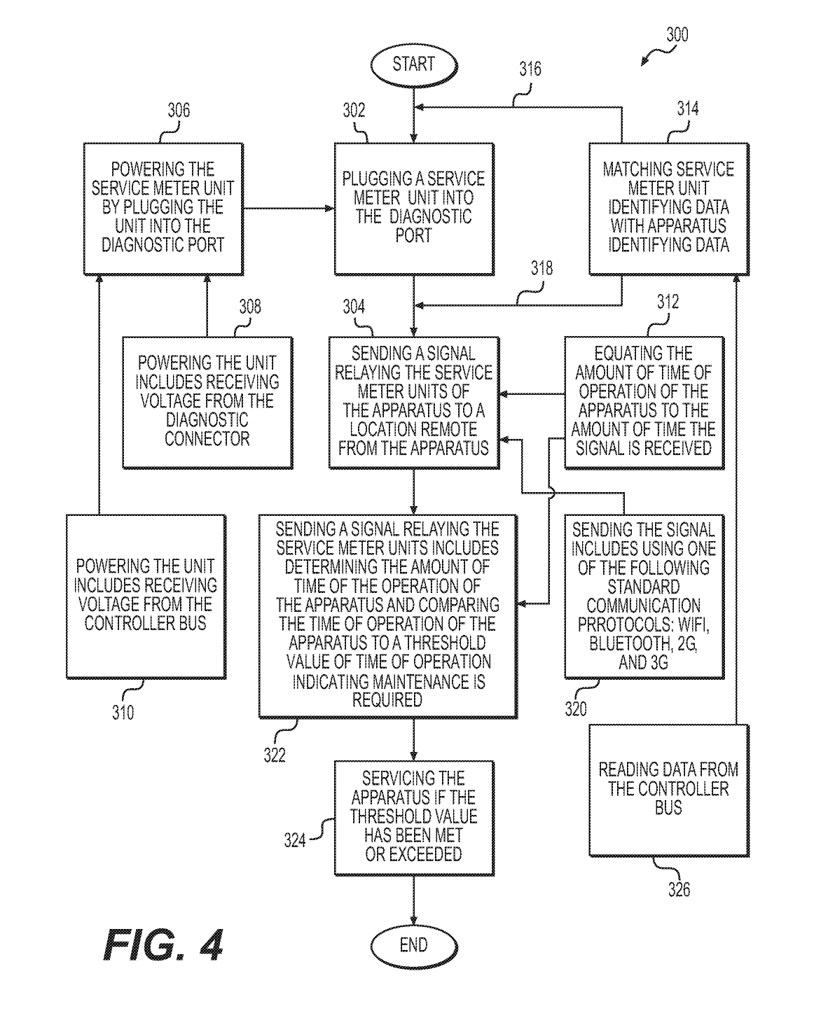

FIG. 4 is a flowchart showing a method of servicing equipment based on the time of operation of the equipment. More specifically, a method for servicing an apparatus based on the time of operation of the apparatus, wherein the apparatus includes a controller BUS and a diagnostic port in communication with the BUS is shown. The method 300 comprises plugging a service meter unit into the diagnostic port (step 302) and sending a signal conveying service meter units to a location remote from the apparatus (step 304). Examples of service meter units includes mileage traversed by a machine, hours of operation of an apparatus such as a machine or engine, etc.

The method may further comprise powering the service meter unit by plugging the unit into the diagnostic port (step 306). In such a case, powering the unit includes receiving voltage from the diagnostic connector (step 308). In other cases, powering the unit includes receiving voltage from the BUS controller (step 310).

The step of sending a signal related to the time of operation of the apparatus may include equating the amount of time of operation of the apparatus to the amount of time the apparatus is in operation (step 312).

In some applications, the method may further comprise matching service meter unit identifying data with apparatus identifying data (step 314). The matching step may be performed before the plugging step (step 316) or the matching step may be performed after the plugging step (step 318). The matching step may also include reading data from the controller BUS (step 326). This may involve reading the serial number of the apparatus from the BUS.

In many embodiments, sending the signal includes using one of the following standard communication protocols: Wi-Fi, Bluetooth, 2G, and 3G (step 320). In such a case, an IoT chipset or the like configured to use such communication protocols may be part of the transmitter.

The method may further comprise determining the amount of time of the operation of the apparatus and comparing the time of operation of the apparatus to a threshold value of time of operation indicating maintenance is required (step 322). Determining step 322 may involve the equating step 312 or reading or decoding data sent from the controller BUS, etc. Once the time of operation has been determined, the method may further comprise servicing the apparatus if the threshold value has been met or exceeded (step 324).

It is to be understood that the time of operation is a relative parameter that may be reset once servicing has been performed. In other embodiments, the time of operation may not be reset but may indicate service intervals. Also, different thresholds may be established for different servicing tasks such as changing the oil, rotating the tires, etc. Accordingly, different times of operation relative to each servicing task may be tracked. So, the method and apparatus described herein should be interpreted broadly to include such embodiments. Furthermore, the term “processor” should be interpreted broadly and include any type of controller, microcontroller, microprocessor, hard wired circuitry or logic, etc. that is configured to manipulate or generate data that is then sent by a device, etc.

Once the threshold has been met, notification may be sent to the user in various ways including sending email reminders, texts to a mobile phone, via monitoring services who contact the end user, software applications, etc.

For any embodiment discussed herein, the device may be used for any and all equipment with a communication BUS. This includes off road or highway applications, highway commercial vehicles or other similar machines, highway personal vehicles, etc. In addition to or in lieu of the connectors shown in the drawings, the device can have a SAE J1939 nine pin connector, J1708 six pin connector, J1850 automotive connector or any other OBD (on board diagnostic) connector type, etc.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A device for tracking or relaying a service meter unit of an apparatus that includes a diagnostic port, the device comprising:
a plug interface including at least one voltage receiving member; and
a transmitter that is configured to send a signal to a location remote from the device when the device receives voltage from the plug interface.

2. The device of claim 1 wherein the signal is configured to convey the time of operation of the apparatus.

3. The device of claim 1 wherein the signal is configured to convey the identity of the apparatus or the identity of the device.

4. The device of claim 1 further comprising a processor, wherein the processor is configured to track time the device receives voltage, or the processor is configured to send data via the transmitter via regarding the identity of the device or the apparatus.

5. The device of claim 4 wherein the data regarding the identity of the device or the apparatus is preprogrammed into the processor before the device is plugged into the apparatus.

6. The device of claim 4 further comprising a data input interface and the processor is programmed with data regarding the identity of the apparatus through the data input interface.

7. The device of claim 6 wherein the plug interface includes the data input interface.

8. An apparatus comprising:
a controller including a controller BUS;
a BUS diagnostic port including a connector in communication with the BUS; and
a service meter unit connected to the diagnostic port, the service meter unit including
a transmitter configured to send a signal to a location remote from the apparatus when the service meter unit receives voltage from the apparatus.

9. The apparatus of claim 8 wherein the connector supplies a diagnostic connector voltage and the received voltage is the diagnostic connector voltage.

10. The apparatus of claim 8 wherein the controller BUS supplies at least one of a controller BUS high voltage, controller BUS low voltage and a controller BUS shield voltage and the received voltage is at least one of the controller BUS high voltage, the controller BUS low voltage or the controller BUS shield voltage.

11. A method for servicing an apparatus based on the time of operation of the apparatus, wherein the apparatus includes a controller BUS and a diagnostic port in communication with the BUS, the method comprising:
plugging a service meter unit into the diagnostic port; and
sending a signal relaying the service meter units of the apparatus to a location remote from the apparatus.

12. The method of claim 11 further comprising powering the service meter unit by plugging the unit into the diagnostic port.

13. The method of claim 12 wherein powering the unit includes receiving voltage from the diagnostic connector.

14. The method of claim 11 wherein sending a signal relaying the service meter units includes determining the time of operation of the apparatus and includes equating the amount of time of operation of the apparatus to the amount of time the signal is received.

15. The method of claim 11 further comprising matching service meter unit identifying data with apparatus identifying data.

16. The method of claim 15 wherein the matching step is performed before the plugging step.

17. The method of claim 15 wherein matching step is performed after the plugging step.

18. The method of claim 11 wherein sending the signal includes using one of the following standard communication protocols: Wi-Fi, Bluetooth, 2G, and 3G.

19. The method of claim 14 further comprising determining the amount of time of the operation of the apparatus and comparing the time of operation of the apparatus to a threshold value of time of operation indicating maintenance is required.

20. The method of claim 19 further comprising servicing the apparatus if the threshold value has been met or exceeded.
